(19) United States
(12) Patent Application Publication
(10) Pub. No.: US 2002/0037362 A1
(43) Pub. Date: Mar. 28, 2002

(54) METHOD OF AND ARRANGEMENT FOR PRODUCING A FLUORESCENT LAYER

(76) Inventors: HERFRIED WIECZOREK, AACHEN (DE); MINHEL T. H. VAN DE VORST, EINDHOVEN (NL)

Correspondence Address: U S PHILIPS CORPORATION, INTELLECTUAL PROPERTY DEPARTMENT, 580 WHITE PLAINS ROAD, TARRYTOWN, NY, 10591

(21) Appl. No.: 09/441,947

(22) Filed: Nov. 17, 1999

(30) Foreign Application Priority Data
Nov. 20, 1998 (DE) 19853605.4

(51) Int. Cl. B05D 5/06; B05D 5/12

(52) U.S. Cl. 427/65; 427/157

(57) ABSTRACT

In a method of and an arrangement for producing a fluorescent layer on a substrate (12), being supported by a substrate holder (11), the temperature of the substrate (12) and of the substrate holder (11) is controlled by introducing a gas into a cavity (14) between the substrate and the substrate holder in order to realize a thermal coupling between the substrate and the substrate holder.

The invention relates to a method of and an arrangement for producing a fluorescent layer on a substrate which is supported by a substrate holder, the temperature of the substrate and of the substrate holder being controlled.

Fluorescent layers of this kind are used in X-ray detectors for the conversion of X-rays into visible or ultraviolet light.

DE 195 19 775 A1 describes a method of producing doped alkali halide vapor deposition layers. The alkali halide layer and the doping agent are then deposited on a rotating substrate by means of two vapor deposition devices. The vapor deposition process takes place in vacuum at a pressure of approximately 10⁻³ Pascal. The temperature of the substrate is controlled by way of a heating lamp and a cooling plate which are arranged above the vapor deposition device and the substrate.

For the deposition of layers on substrates for the manufacture of detectors it is particularly important to realize a uniform temperature distribution across the entire substrate in order to achieve a homogeneous fluorescent layer. Overheating of the substrate during the vapor deposition process would have an adverse affect on the properties of the fluorescent layer, notably on the spatial resolution and the luminous efficacy.

Therefore, it is an object of the invention to provide a method and an arrangement in which the strong heating of the substrate during the vapor deposition process is controlled.

This object is achieved in that a gas is introduced into a cavity between the substrate and the substrate holder in order to realize thermal coupling between the substrate and the substrate holder.

A flat cavity is formed between the substrate holder and the substrate supported thereby. During the vapor deposition process the substrate is mechanically pressed against the substrate holder. The vapor deposition of the fluorescent layer on the substrate takes place in vacuum. After the evacuation of the complete deposition chamber, this cavity or recess is also evacuated. The cavity is vacuum technically separated from the deposition chamber. The sealed cavity thus formed between the substrate and the substrate holder is filled with an externally supplied gas. It has been found that a gas of low molecular weight is advantageously used for this purpose. Particularly suitable in this respect is helium which features low weight and safe handling in comparison with hydrogen. This gas is applied to the cavity at a suitable pressure. The pressure at which the gas is introduced into the cavity is subject to a compromise between some bending of the substrate on the one hand and suitable thermal coupling between substrate and substrate holder on the other hand.

It may be advantageous when the gas to be introduced has a pressure below 10 mbar. Adequate thermal conductivity can be ensured in the case of a pressure of from approximately 5 to 10 mbar while bending of the substrate, due to the vacuum, can be counteracted. Controlling the substrate temperature prevents overheating of the substrate, notably of the detector structures.

The fluorescent layer in an embodiment of the invention advantageously consists of a thallium (Tl) doped cesium iodide layer (Cs:I). The temperature control by means of the helium gas results in a constant substrate temperature enabling uniform growth of the alkali halide needles. Other gases, for example nitrogen or gas compounds, can also be used in as far as they enable suitable thermal coupling. The temperature control creates ideal conditions for growth, enabling the formation of fluorescent layers with a high luminous efficacy and a suitable spatial resolution.

During the deposition of scintillator layers or fluorescent layers the temperature of the substrate strongly increases so that the detector could be damaged. Fluorescent layers deposited at a high temperature have a low spatial resolution only. Because of the high temperatures, the needle structure of the fluorescent layer also changes, so that the spatial resolution of the detector is strongly reduced. Moreover, in the case of strong heating the doping agent could be partly resublimated from the deposited fluorescent layer; this has an adverse effect on the luminescent properties of the fluorescent layer, resulting in a lower luminous efficacy and prolonged afterglow. The growth of cold deposited fluorescent layers is amorphous and their luminescence is poor or even non-existent.

For the quality of the X-ray detector and also of the X-ray images produced thereby it is very important to remain within a given temperature range during the manufacture of such fluorescent layers. The higher the luminous efficacy of the fluorescent layer, the smaller X-ray dose need be applied so as to obtain an acceptable X-ray image.

The method according to the invention enables separate adjustment of the temperature for the seed layer and that for a volume layer, so that the spatial resolution and the luminous efficacy of the fluorescent layer are separately optimized.

An embodiment of the invention will be described in detail hereinafter, by way of example, with reference to the drawings.

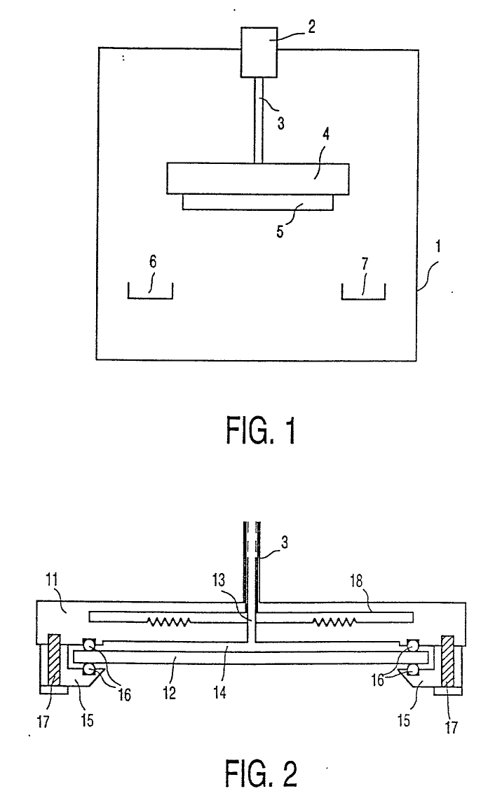

FIG. 1 shows a deposition chamber, and

FIG. 2 shows diagrammatically the composition of the substrate and the substrate holder.

FIG. 1 shows a vapor deposition system which consists of a deposition chamber 1 and a substrate holder 4 on which there is arranged a substrate 5. A gas for tempering the substrate holder 4 and the substrate 5 is supplied via a duct (not shown) in a drive shaft 3. The substrate holder 4 and the substrate 5 supported thereby perform a rotary motion, via a drive 2, during the vapor deposition process. The references 6 and 7 denote vapor deposition devices containing, for example cesium iodide (6) and thallium iodide (7). These two devices are heated via a separate heating system (not shown) until the substance contained therein reaches its melting point. At a higher temperature the relevant substance evaporates or sublimates and is deposited on the rotating substrate. The substrate 5, supported by the substrate holder 4, preferably consists of glass. An alkali halide, for example cesium iodide with a doping agent such as, for example thallium iodide, is vapor deposited on the glass substrate. The substrate holder is made of, for example aluminium.

FIG. 2 shows the substrate holder 11, the substrate 12, pressure pieces 15, sealing rings 16, a cavity 14, screws 17, an electric heating system 18 and a duct 13 in the drive shaft 3. For example, an electric heating system 18 is provided in the substrate holder 11. Pressure pieces 15 are mounted on the substrate holder 11, said pieces being screwed thereto via screws 17. The substrate 12, customarily consisting of glass, bears on sealing rings 16 which are arranged in the pressure pices 15 on the one side and in the substrate holder 11 on the other side of the substrate.

The substances to be deposited are contained in the vapor deposition devices 6 and 7. The substances are heated to their melting point via separate heating systems. The ratio of the amounts of Cs:I and Tl:I to be deposited can be adjusted by way of the size of the aperture of the vapor deposition device and the angle at which this device is arranged relative to the substrate 12. The vapor deposition process is carried out in vacuum. To this end, the deposition chamber 1 is evacuated. Subsequently, the substrate is pressed against the substrate holder by way of the pressure pieces 15. The sealing rings 16 create a cavity 14 which is separated from the other vacuum space. The substrate holder and the substrate are pre-heated via the heating system 18 so that they quickly enter the ideal temperature range. For Cs:I doped with Tl it has been found that the vapor deposition process is advantageously carried out in a temperature range of from 180 to 220° C. In order to sustain this temperature during the entire process for forming the fluorescent layer, thermal coupling is realized between the substrate and the substrate holder; this coupling is realized by means of the tempered helium gas which is introduced into the cavity 14 via the duct 13 in the drive shaft 3.

The tempered helium gas is introduced into the cavity 14 and a pressure below 10 mbar is adjusted. In the case of large substrates, which bend in the direction of the deposition chamber under the influence of the pressure, a suitably lower pressure is to be applied so as to prevent such bending. On the other hand, the thermal conductivity increases as the pressure is higher, so that a compromise must be found between bending and suitable thermal coupling. The indicated pressure of less than 10 mbar enables uniform tempering at which a homogeneous fluorescent layer with a maximum luminous efficacy can be formed. The cavity, being filled with the helium, is connected to a circuit (not shown) so that a continuous gas flow provides uniform adjustment of the pressure and hence a constant temperature for the vapor deposition process under uniform pressure conditions.

1. A method of producing a fluorescent layer on a substrate (12) which is supported by a substrate holder (11), the temperature of the substrate (12) and of the substrate holder (11) being controlled, characterized in that
a gas is introduced into a cavity (14) between the substrate and the substrate holder in order to realize thermal coupling between the substrate and the substrate holder.

2. A method of producing a fluorescent layer as claimed in claim 1, characterized in that
the gas to be introduced has a temperature of from 100 to 350° C. while the bending of the substrate (12) and the thermal coupling between the substrate (12) and the substrate holder (11) are adjustable by means of a pressure which is less than or equal to 10 mbar.

3. A method of producing a fluorescent layer as claimed in claim 1, characterized in that
the fluorescent layer consists of a layer of thallium-doped cesium iodide.

4. A method of producing a fluorescent layer as claimed in claim 1, characterized in that
the gas used is a gas having a low molecular weight, notably helium.

5. An arrangement for producing a fluorescent layer on a substrate (12) which is supported by a substrate holder (11), characterized in that a cavity (14) is provided between the substrate (12) and the substrate holder (11), which cavity (14) is formed by pressing the substrate against the substrate holder, while utilizing sealing by means of sealing rings (16), and can be filled with a gas via a duct (13).
